(19) United States
(12) Patent Application Publication
(10) Pub. No.: US 2005/0170167 A1
(43) Pub. Date: Aug. 4, 2005

(54) Synthetic fiber containing powders with the shape of hollow sphere

(76) Inventors: Won-Bae Kim, Incheon (KR); Kwang-Bae Kim, Seoul (KR); Yun-Sung Kim, Gyunggi-do (KR); Gun-Jik Lee, Seoul (KR); Yong-Jin Chun, Chungcheongnam-do (KR); Chang-Uk Jung, Gangwon-do (KR)

Correspondence Address: PIPER RUDNICK LLP, P. O. BOX 9271, RESTON, VA, 20195, US

(21) Appl. No.: 10/513,706

(22) PCT Filed: May 7, 2002
(86) PCT No.: PCT/KR02/00847

(30) Foreign Application Priority Data
May 6, 2002 (KR) 2002/24786

(51) Int. Cl. B32B 3/26; B32B 3/00

(52) U.S. Cl. 428/313.3; 428/372

(57) ABSTRACT

Disclosed is a synthetic fiber, including hollow sphere-shaped particles each formed of any one selected from among an inorganic material, an organic material, or combinations thereof, which is advantageous in terms of a low specific gravity, thereby effectively solving conventional wearing problems.

### TECHNICAL FIELD

The present invention relates to synthetic fibers including hollow sphere-shaped particles. More specifically, the present invention is directed to a synthetic fiber, characterized by having lightweight due to the hollow particles therein, and various functions according to materials constituting the hollow spheres.

### BACKGROUND ART

With advances in fiber technologies, functional synthetic fibers have been developed to have various properties, for example, the emission of far infrared rays, antibacterial activity, antistatic function, ultraviolet protection, magnetic properties, deodorizing functions, and electromagnetic wave blocking properties, which are beneficial to humans. In particular, synthetic fibers having some of the above properties are successfully produced and presently commercially available.

To obtain fibers having the above properties, there are disclosed methods of introducing an inorganic particle material capable of providing the desired properties into a fiber. However, in cases where fibers are prepared by means of the above method, the preparation processes of fibers have many problems. As well, the prepared fibers may have inferior properties. Further, the inorganic particle material having a high specific gravity is introduced into the fiber, whereby the fibers have an increased specific gravity. Hence, clothes made of such fibers have a heavy feeling upon wearing thereof.

### DISCLOSURE OF THE INVENTION

Therefore, it is an aspect of the present invention to alleviate the problems encountered in the related art and to provide a fiber having a low specific gravity with various functions.

Another aspect of the present invention is to provide a functional fiber having various applications, by being easily used for applications of conventionally used fibers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an enlarged photograph of polystyrene microspheres each having a uniform size,

FIG. 2 is an enlarged photograph of hollow silica spheres; and

FIG. 3 is an enlarged photograph illustrating an internal cavity of respective hollow silica spheres.

### BEST MODE FOR CARRYING OUT THE INVENTION

Based on the present invention, a synthetic fiber includes hollow spheres each formed of an inorganic material or an organic material.

In cases where an inorganic particle material is used for the preparation of the synthetic fiber, since the inorganic particle material has a specific gravity much higher than that of the resin for use in the synthetic fiber, the specific gravity of the fiber increases proportionally with the amount used of the inorganic material.

Therefore, with the aim of solving the problems concerning the high specific gravity of the fiber, hollow sphere-shaped particles are used in the present invention. As such, the used hollow spheres should have an apparent specific gravity of 0.5 or less, so that a specific gravity of the fiber is effectively reduced. If the apparent specific gravity exceeds 0.5, the hollow spheres are used in excessive amounts, which has a negative influence on the physical properties of the fiber.

Moreover, the hollow spheres have a variety of applications, of which they mainly serve to reduce the weight of end products and impregnate effective ingredients, attributable to internal cavities thereof. In addition, the hollow spheres have been employed for paints, plastics, rubbers, synthetic woods, cosmetics, fire resisting materials, agricultural chemical-impregnating agents, etc. Representative inorganic hollow spheres commercially available are exemplified by silica, alumina, and fly ash, in which particle sizes, shapes, and particle size distributions of the hollow spheres depend on the use purposes or prices thereof.

In terms of a particle size, when a material having a larger particle size is used for a spinning process, a spinning pack may be plugged or fibers may be cut, whereby the desired yarns cannot be normally produced. Also, the produced synthetic fiber is rough on a surface thereof, and has low strength. Thus, the physical properties of the fiber per se become poor.

Hence, as the size of the hollow spheres decreases, the properties of the fibers becomes better or the preparation process thereof becomes easier. In this regard, the fibers used in clothes of about 1.5 denier or less, which have an average size of about 0.5 μm or less, a 90% particle size of about 1 μm or less and a maximum size of 2 μm or less, may be reliably produced to be suitable for desired applications. However, the above numerical ranges of particle sizes are not strictly applied. In particular, in cases of spherical particles, since the cohesion between particles is low, the particles do not cause problems even though they have slightly larger sizes. Further, if the particles have smaller sizes, preparation problems rarely surface. Also, fibers with excellent properties can be obtained.

Among hollow spheres presently commercially available, there exist many hollow spheres not satisfying the above requirements of the particle size. This is because such available particle materials are not originally intended for fiber applications.

The particle size as mentioned above, resulting from many studies of the present inventors, further includes an irregular shape and size distribution of particles. If the hollow spheres have practically a uniform particle size and are almost perfectly spherical, there is no cohesion between the particles.

Accordingly, even though the hollow spheres have the average particle size of about 1 μm, serious problems concerning the preparation of the fibers do not occur.

Likewise, organic hollow spheres made of polystyrene are presently commercially available. Further, a method of preparing organic hollow spheres is disclosed in U.S. Pat. No. 4,427,836 and Korean Patent No. 80123. The organic hollow spheres are used to increase the masking effects and whiteness by scattering entered light due to different refractive indexes between internal cavities and polymer shells surrounding such cavities.

To provide other functions in addition to reducing the weight of the fibers, there are proposed methods of using powders of a second material exhibiting desired functions in the shape of solid spheres, as well as a first material having hollow spheres. However, the above method is disadvantageous in that the hollow spheres of the first material, acting to reduce the specific gravity of fibers, and the powders of the second material having other functions are separately added, and thus a total adding amount becomes high, which adversely affects the preparation process of the fibers. Also, the physical properties of the fiber per se may degrade. Therefore, although being practically usable, the above method is unsuitable.

Further, there are proposed methods of directly preparing hollow spheres by use of a material having a desired function. For example, conductive powders are used to synthesize hollow spheres. If this happens, synthetic fibers including thusly synthesized hollow spheres are advantageous in terms of lightweight, and superior antistatic functions.

In addition, hollow spheres having desired sizes may be variously prepared. For instance, microspheres of an organic polymer are used as an intermediate to prepare micro particles as in the present invention. By means of organic synthesis, fine spherical particles of the organic polymer are made, on which a desired material is thinly coated, after which only the internal organic polymers are removed. Thereby, externally coated shells remain, thus obtaining desired hollow spheres. In such a case, the internal organic polymer is removed by a burning process or by dissolving it in an organic solvent.

Alternatively, hollow spheres coated with a desired functional material may be used as they are.

As for the preparation methods of fibers, an air stream extruding method may be adopted, in addition to commonly used spinning methods of synthetic fibers.

A better understanding of the present invention may be obtained in light of the following examples which are set forth to illustrate, but are not to be construed to limit the present invention.

### EXAMPLE 1

From commercially available hollow silica spheres having an apparent specific gravity of 0.15 g/cc, an average particle size of 2 μm and 98% of SiO₂, silica having small sizes were separated, which had an apparent specific gravity of 0.18 g/cc, an average particle size of 0.65 μm and a 90% particle size of 1.3 μm, and a maximum size of 2.2 μm.

Thusly separated hollow spheres were subjected to a master batch preparation process along with a polypropylene resin, to prepare a polypropylene master batch chip having 10 wt % of hollow silica spheres, which was then further mixed with a polypropylene resin and subjected to a synthetic fiber spinning process, thus preparing a polypropylene yarn of 1.2 denier containing 1.5 wt % of hollow silica spheres.

The prepared fiber had a density ratio of 0.96, in which a density ratio means a value obtained by dividing the specific gravity of a yarn containing hollow spheres by the specific gravity of a yarn containing elvan powder of weight equivalent to the hollow spheres.

### EXAMPLE 2

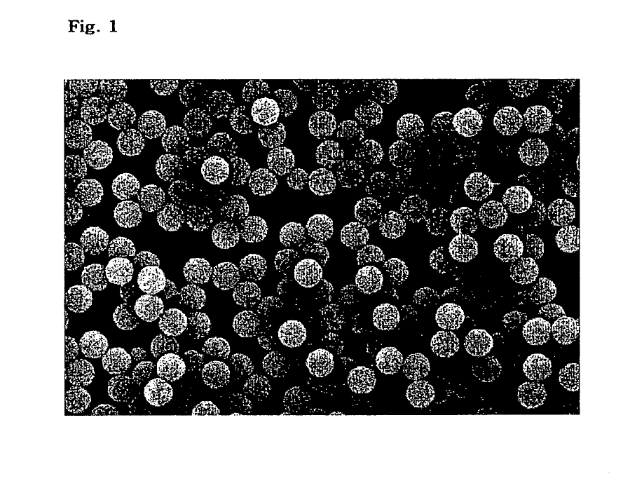

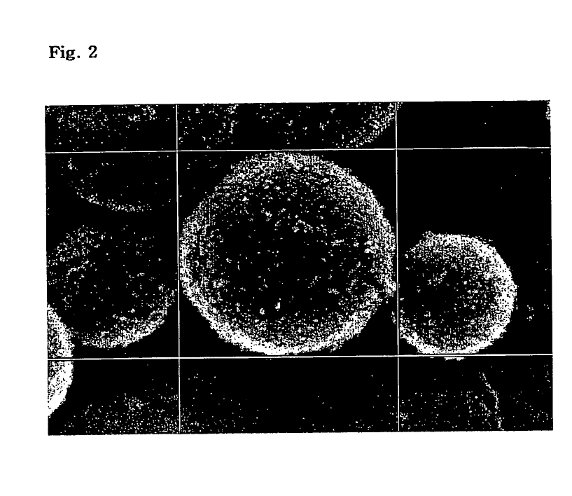

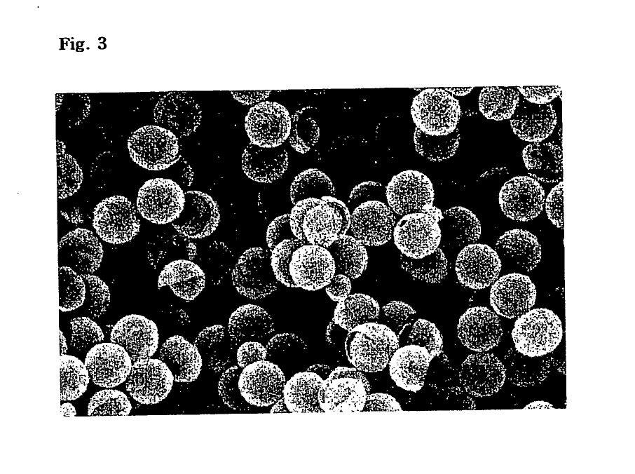

Through an emulsion polymerization, the microspheres of polystyrene having a uniform size were synthesized and separated from the emulsion (FIG. 1). Then, TEOS (Tetra Ethyl Ortho Silicate) was hydrolyzed and coated onto the microspheres, which were then dried. Internal polystyrene was dissolved in methylene dichloride to obtain hollow silica spheres (FIG. 2). As for the hollow silica spheres, particles had a uniform size and a diameter of 1.0 μm. To confirm the shape of these silica particles, the particles were destroyed and observed. From this, it can be seen that silica is in the shape of hollow spheres (FIG. 3).

The hollow spheres were subjected to the processes same as in example 1, to yield a polypropyele yarn of 1.2 denier containing 1.5 wt % of hollow silica spheres. The density ratio was 0.94.

### EXAMPLE 3

Through a LBL (Layer By Layer) adsorption, 20 nm sized ultrafine particles of SiO₂ were adsorbed three times to spherical polylatex particles, to obtain fine particles of polystyrene latex coated with ultrafine particles of SiO₂, which were then heat-treated to remove an internal organic material. Thereby, SiO₂ hollow spheres each having a diameter of 0.6 μm were obtained.

The hollow spheres were subjected to the processes the same as in example 1, to yield a polypropyele yarn of 1.2 denier containing 1.5 wt % of SiO₂ hollow spheres. The density ratio was 0.96.

### EXAMPLE 4

The SiO₂ hollow spheres obtained in example 3 were immersed in a silver nitrate solution to incorporate a silver component into respective hollow spheres, which were then removed from the solution, dried and burnt to produce SiO₂ hollow spheres each containing 4 wt % of silver.

A spinning process was performed as in example 1, thereby obtaining a polypropylene yarn of 1.2 denier containing 1.5 wt % of SiO₂ hollow spheres each having 4 wt % of silver. The density ratio was 0.97.

To confirm antibacterial activity of the yarn, antibacterial test on E. coli was carried out. From this, the antibacterial activity was found to be 99% or more. However, the yarn prepared in example 3 had no antibacterial activity.

### EXAMPLE 5

The SiO₂ hollow spheres obtained in example 3 were immersed in a SnC₄ solution, and separated from a filtrate, and then further immersed in a SbCl₃ solution, neutralized with ammonia, dried, and then heat-treated at 600° C. for one hour, to obtain a conductive mixture having Sn:Sb of 8.8:1 as a weight ratio and SiO₂:[(Sn+Sb) oxide] of 3.2:1 as a weight ratio.

The obtained conductive mixture was subjected to a spinning process as in example 1, thereby preparing a polypropylene yarn of 1.2 denier containing 1.5 wt % of the conductive mixture. The density ratio was 0.97.

The polypropylene yarn had a specific resistivity 1/10,000 lower than that of the yarn prepared in example 3, thereby exhibiting an antistatic function.

### EXAMPLE 6

Zeolite antibacterial material (average particle size 0.5 μm, 90% particle size 1.0 μm, maximum size 1.8 μm) containing 5 wt % of silver was mixed with hollow silica spheres used in example 2 at a weight ratio of 3:1. By use of thusly obtained mixture and general polyester chips, a master batch chip containing 10% of an inorganic material was made and mixed with general polyester chips, and then subjected to a spinning process, to prepare a yarn of 1.4 denier having 2.0 wt % of the inorganic material and a density ratio of 0.97. By an antibacterial test performed to confirm the antibacterial activity of the yarn, the antibacterial activity thereof was found to be 99% or more.

### EXAMPLE 7

The hollow silica spheres used in example 3 were mixed with ethyleneglycol and made in a state of a slurry, which was then subjected to a polyester chip polymerization process, to prepare a polyester compound chip containing 2 wt % of hollow silica spheres. The polyester compound chip was subjected to a spinning process, thus affording a polyester yarn of 1.2 denier containing 2 wt % of hollow silica spheres. The density ratio was 0.97.

### Industrial Applicability

As described above, the present invention provides a synthetic fiber including hollow spheres. Such a synthetic fiber has physical properties suitable for use in clothes and beddings, and lighter weight, compared to general fibers. Thereby, heavy wearing problems, regarded as the worst of conventional functional fiber products, can be essentially solved. Thus, functional synthetic fibers can be variously applied.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A synthetic fiber, comprising hollow spheres each made of any one selected from among an inorganic material, an organic material, or combinations thereof.

2. The synthetic fiber as defined in claim 1, wherein the hollow spheres each have an apparent specific gravity of 0.5 or less.

3. The synthetic fiber as defined in claim 1, wherein the hollow spheres have an average particle size of 0.5 μm or less, a 90% particle size of 1 μm or less, and a maximum size of 2 μm or less.

4. The synthetic fiber as defined in claim 1, further comprising a functional inorganic material.

5. The synthetic fiber as defined in claim 1, wherein the hollow spheres each are coated with a functional inorganic material.

6. The synthetic fiber as defined in claim 1, wherein the hollow spheres each are made of a functional inorganic material.

7. The synthetic fiber as defined in claim 4 wherein the functional inorganic material is selected from the group consisting of far infrared-emitting materials, conductive materials, antibacterial materials, electromagnetic wave-absorbing materials, ultraviolet protective materials, X-ray blocking materials, deodorizing materials, magnetic materials, and optical materials.

8. The synthetic fiber as defined in claim 5, wherein the functional inorganic material is selected from the group consisting of far infrared-emitting materials, conductive materials, antibacterial materials, electromagnetic wave-absorbing materials, ultraviolet protective materials, X-ray blocking materials, deodorizing materials, magnetic materials, and optical materials.

9. The synthetic fiber as defined in claim 6, wherein the functional inorganic material is selected from the group consisting of far infrared-emitting materials, conductive materials, antibacterial materials, electromagnetic wave-absorbing materials, ultraviolet protective materials, X-ray blocking materials, deodorizing materials, magnetic materials, and optical materials.
